(19) United States
(12) Patent Application Publication
(10) Pub. No.: US 2019/0380906 A1
(43) Pub. Date: Dec. 19, 2019

(54) FLOOR MAT

(71) Applicant: Sourceman Inc., Chino, CA (US)

(72) Inventor: Chieh Jen Lin, New Taipei City (TW)

(21) Appl. No.: 16/186,379

(22) Filed: Nov. 9, 2018

(30) Foreign Application Priority Data
Jun. 15, 2018 (CN) 201810622693.6

(51) Int. Cl. A61H 15/00

(52) U.S. Cl. CPC A61H 15/00; A61H 2015/0042; A61H 2201/164; A61H 2015/005; A61H 2201/1253; A61H 2015/0014

(57) ABSTRACT

The present application provides a floor mat comprising a main body and a changeable roller. The main body comprises an accommodation space. The changeable roller is arranged in the accommodation space of the main body. The changeable roller comprises a base, a massager, and a cover. The cover is coupled to the base to form a massager space and comprising at least one opening, wherein the massager is restricted in the massager space and exposed partially from the at least one opening.

### CROSS-REFERENCE TO RELATED APPLICATIONS

This application claims priority benefit from China Patent Application No. 201810622693.6, filed on Jun. 15, 2018 in the State Intellectual Property Office of the P.R.C, the disclosure of which is incorporated herein by reference in its entirety.

### TECHNICAL FIELD OF THE INVENTION

The present application generally relates to floor mats, and more particularly, to a floor mat with a changeable roller.

### BACKGROUND OF THE INVENTION

With the evolution of social civilization, the lifestyle of people has become increasingly tense and busy. From this evolution, more people are living in the fast-paced society. Although society advancement nowadays reduces the need of heavy labor from people, the degree of mental and physical exertion has become worse due to the compactness of life.

In the past, floor mat products are introduced to solve the problems for workers who needed to stand for a long time, such as workers at the department stores, supermarkets, gas stations, laboratories, or kitchens, and office workers who used to stand up to work. The floor mat product relieves the workers' leg pressure and body fatigue caused by the prolonged standing.

Although a conventional working floor mat can relieve the foot pressure and the tension of the legs, there are still greater needs for an improved floor mat to provide a better quality and relaxation that can improve working efficiency of workers.

### SUMMARY OF THE INVENTION

In view of this, the object of the present application is to provide a floor mat that not only relieves the pressure on the user's legs and reduces the fatigue caused by standing for a long time, but also provides users with further relaxation for the body pressure by the rolling massage operation.

In order to achieve the above and other objects, the present application provides a floor mat comprising a main body and a changeable roller. The main body comprises an accommodation space. The changeable roller is arranged in the accommodation space of the main body.

In various exemplary embodiments, wherein the main body is plate-shaped.

In various exemplary embodiments, the changeable roller comprises a base, a massager, and a cover. The cover is coupled to the base to form a massager space and comprising at least one opening, wherein the massager is restricted in the massager space and exposed partially from the at least one opening.

According to an exemplary embodiment of the floor mat, the cover comprises one opening. The base comprises a restricted portion, the restricted portion and the opening are circular, the massager is a ball. The ball is a metal ball.

According to the other exemplary embodiment, the cover comprises one opening. The base comprises two stands. The massager comprises protrusions and at least one rolling wheel, wherein the protrusions are coupled to the two stands, the at least one rolling wheel is coupled to the protrusions. In this embodiment, the at least one rolling wheel is a dumbbell shaped rolling wheel and a surface of the dumbbell shaped rolling wheel is smooth.

According to the other exemplary embodiment, the cover comprises one opening. The base comprises two stands. The massager comprises protrusions and at least one rolling wheel, wherein the protrusions are coupled to the two stands, the at least one rolling wheel is coupled to the protrusions. In this embodiment, the massager further comprises a rod passing through a center of the at least one rolling wheel to form the protrusions. The at least one rolling wheel comprises a plurality of wavy recesses and is ellipsoid. In addition, the present application may comprise one or two rolling wheel.

According to the other exemplary embodiment, the cover comprises two openings. The base comprises two restricted portions, the two restricted portions and the two openings are circular, the massager comprises two balls. The two balls are two metal balls.

According to the other exemplary embodiment, the cover comprises seven openings. The base comprises seven restricted portions, the seven restricted portions and the seven openings are circular, the massager comprises seven balls. The seven balls are seven metal balls.

Based on the above, the floor mat of the present application provides a main body suitable for the user to stand for a long time that not only relieves the pressure on the user's legs and reduces the fatigue caused by standing for a long time, but also has a great efficiency for users to further relax the body pressure by the rolling massage operation.

In addition, the user can change the desired roller for relaxing, enhancing the quality of doing massage by selecting a customized roller.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 is a perspective view of a floor mat according to the first embodiment of the present application.

FIG. 2 is a partially exploded perspective view of the floor mat of FIG. 1.

FIG. 3 is an exploded perspective view of the roller of FIG. 2.

FIG. 4 is a perspective view of a floor mat according to the second embodiment of the present application.

FIG. 5 is a partially exploded perspective view of the floor mat of FIG. 4.

FIG. 6 is an exploded perspective view of the roller of FIG. 5.

FIG. 7 is a perspective view of a floor mat according to the third embodiment of the present application.

FIG. 8 is a partially exploded perspective view of the floor mat of FIG. 7.

FIG. 9 is an exploded perspective view of the roller of FIG. 8.

FIG. 10 is a perspective view of a floor mat according to the fourth embodiment of the present application.

FIG. 11 is a partially exploded perspective view of the floor mat of FIG. 10.

FIG. 12 is an exploded perspective view of the roller of FIG. 11.

FIG. 13 is a perspective view of a floor mat according to the fifth embodiment of the present application.

FIG. 14 is a partially exploded perspective view of the floor mat of FIG. 13.

FIG. 15 is an exploded perspective view of the roller of FIG. 14.

FIG. 16 is a perspective view of a floor mat according to the sixth embodiment of the present application.

FIG. 17 is a partially exploded perspective view of the floor mat of FIG. 16.

FIG. 18 is an exploded perspective view of the roller of FIG. 17.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

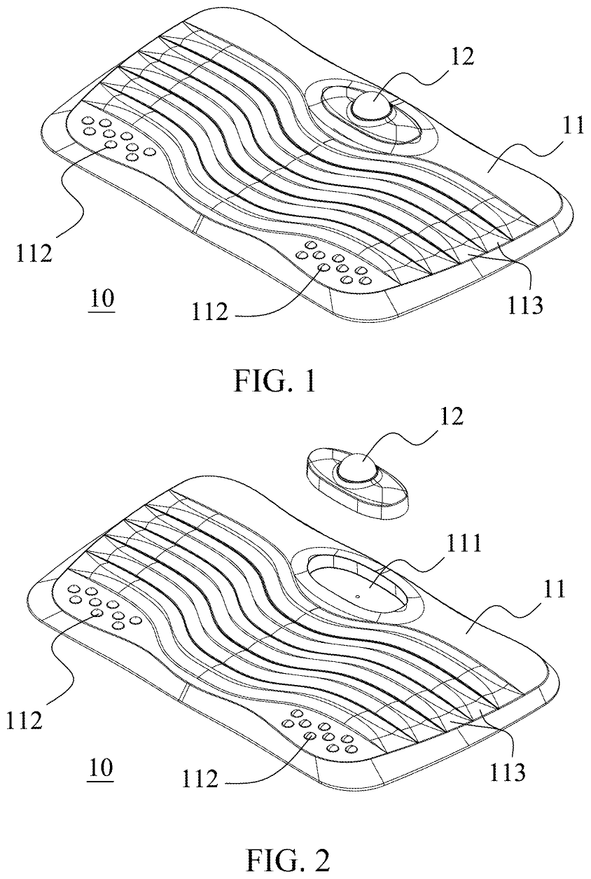

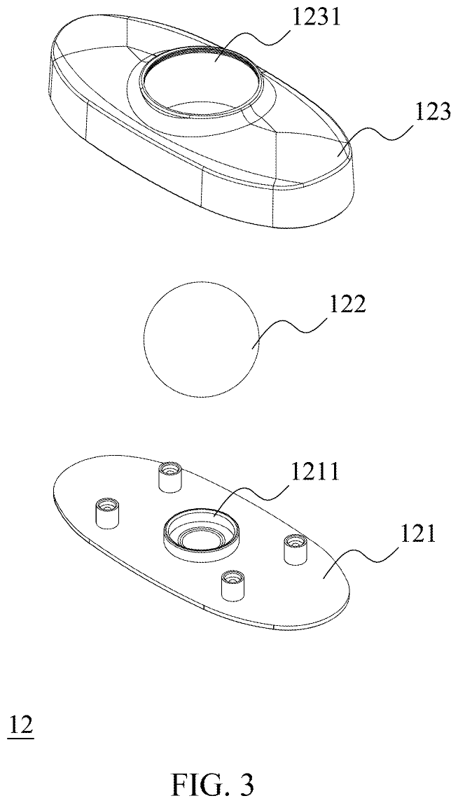

FIG. 1 is a perspective view of a floor mat 10 according to the first embodiment of the present application. FIG. 2 is a partially exploded perspective view of the floor mat 10 of FIG. 1. FIG. 3 is an exploded perspective view of the roller 12 of FIG. 2.

The floor mat 10 comprises a main body 11 and a roller 12. The main body 11 is a plate-shaped body which has a slightly wider width above and a slightly greater thickness than the lower side to provide comfort for a user to stand for a long time. However, the main body 11 can be different shapes as long as the user can stand on it. The main body 11 has an accommodation space 111 at the upper middle position and a plurality of spherical pressure points 112 on the lower left and right sides. The rest of the surface except for the upper left side, right side and the accommodation space of the main body 11 is orderly set with a plurality of lateral wave-like patterns 113 having a wide gentle slope to provide a user with a better sole touch.

The main body 11 can be made of foam, plastic, metal, wood, resin, stone or the combination of the above. The present application is not limited thereto, the main body 11 can comprise any kind of material upon different user needs.

As shown in FIG. 2, the roller 12 is disposed in the accommodation space 111 of the main body 11 for the user to selectively perform, for example, a rolling massage operation on the sole; so the effect of soothing the body pressure can be achieved by pressing the plantar fascia.

The roller is changeable in the present application, meaning that the user may select the desired roller. The different roller will be described along with different figures.

It should be noted that the accommodation space 111 in the present application is oval. However, the present application is not limited thereto, the accommodation space 111 can be different kind of shapes as long as the roller 12 can be fit therein.

In FIG. 3, the roller 12 comprises a base 121, a massager 122 and a cover 123.

The base 121 is coupled with the cover 123 to form a massager space. The base 121 comprises a restricted portion 1211 for supporting the massager 122 more stably. It should be noted that the restricted portion 1211 and the bottom of the base 121 can be made integrally or separately and coupled afterwards, the present application is not limited thereto.

The massager 122 is disposed in the massager space. The massager 122 can be made of any kind of material such as metal or plastic. The massager 122 in FIGS. 1-3 is a ball.

The cover 123 comprises an opening 1231. Specifically, the shape of the opening 1231 is corresponded to the massager 122. For example, the massager 122 of the roller 12 is a ball, so the opening 1231 is circular. Therefore, the massager 122 can be restricted in the massager space and be exposed partially from the opining 1231, allowing the user to massage by utilizing the massager 122.

The combination way of the cover 123 and the base 121 can be accomplished by screws, snaps, guide rails, glue, foamed inside, or tight fit etc. The present application is not limited thereto.

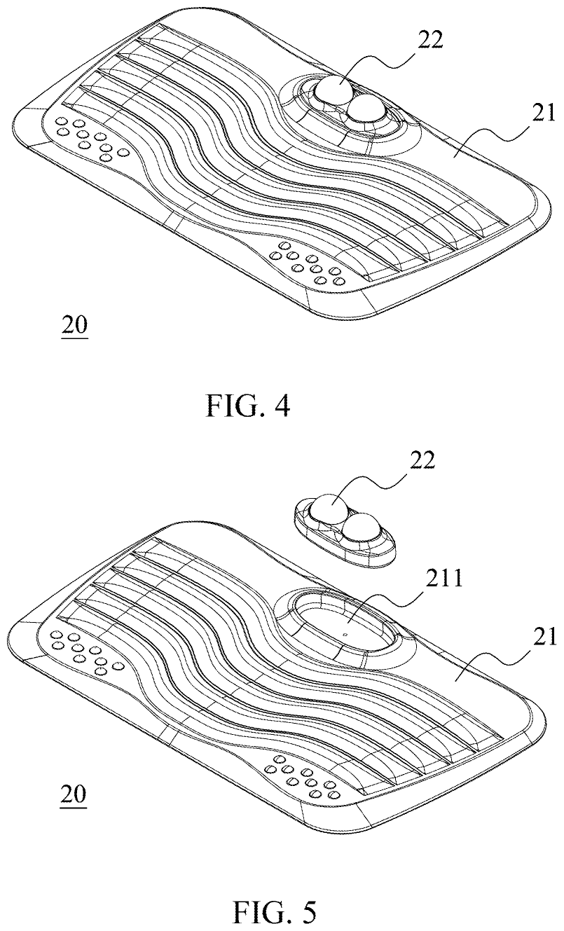

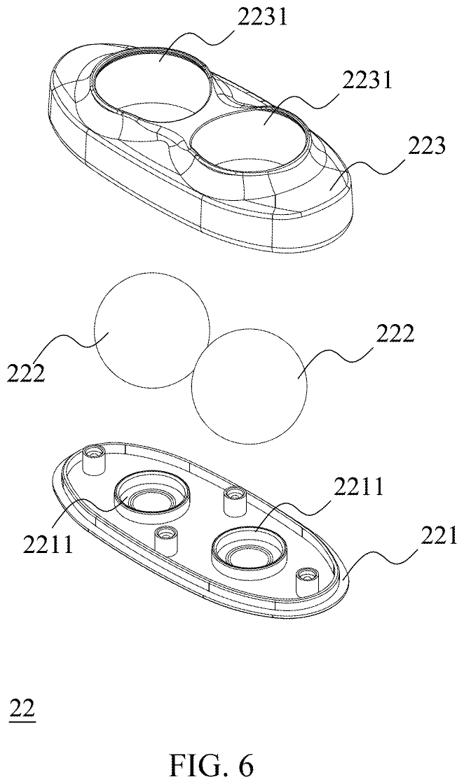

FIG. 4 is a perspective view of a floor mat 20 according to the second embodiment of the present application. FIG. 5 is a partially exploded perspective view of the floor mat 20 of FIG. 4, FIG. 6 is an exploded perspective view of the roller 22 of FIG. 5.

Referring to FIGS. 4-5, the floor mat 20 comprises a main body 21 and a roller 22 disposed in the accommodation space 211 of the main body 21.

In FIG. 6, the roller 22 comprises a base 221, the massagers 222 and a cover 223.

The difference between the floor mat 10 (referring to FIGS. 1-3) and floor mat 20 is the structure of the roller 22. Specifically, the base 221 of the roller 22 comprises two restricted portions 2211 and the cover 223 of the roller 22 comprises two openings 2231. In addition, the massager 222 comprises two balls 222, providing the user a bigger massage area.

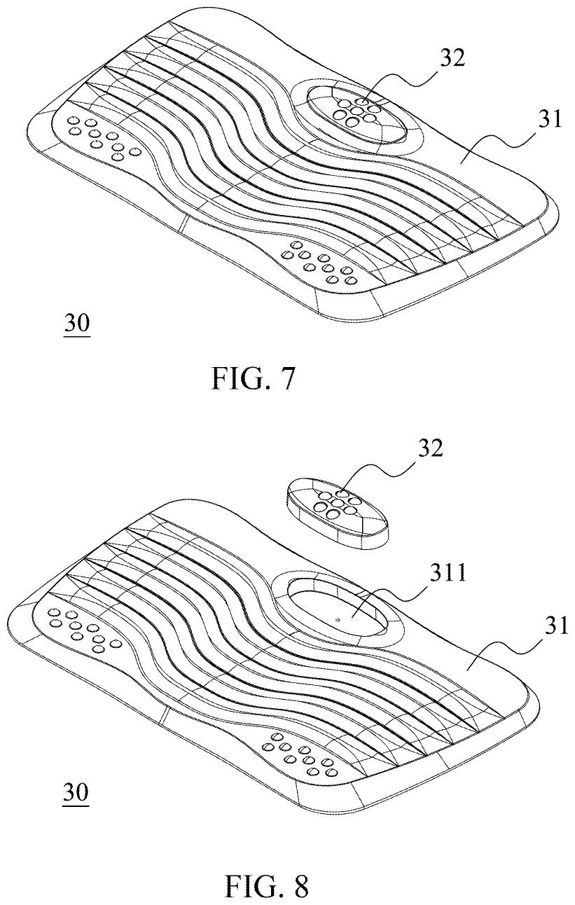

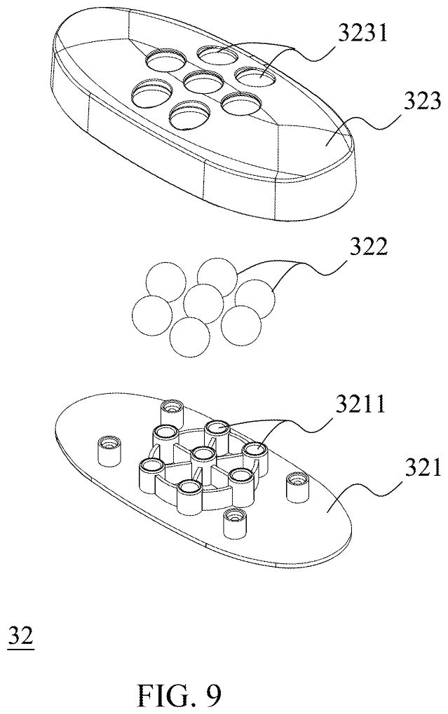

FIG. 7 is a perspective view of a floor mat 30 according to the third embodiment of the present application. FIG. 8 is a partially exploded perspective view of the floor mat 30 of FIG. 7. FIG. 9 is an exploded perspective view of the roller 32 of FIG. 8.

Referring to FIGS. 7-8, the floor mat 30 comprises a main body 31 and a roller 32 disposed in the accommodation space 311 of the main body 31.

In FIG. 9, the roller 32 comprises a base 321, the massagers 322 and a cover 323.

The difference between the floor mat 10 (referring to FIGS. 1-3) and floor mat 30 is the structure of the roller 32. Specifically, the base 321 of the roller 32 comprises seven restricted portions 3211 and the cover 323 of the roller 32 comprises two openings 3231. In addition, the massager 322 comprises two balls 222, providing the user a smaller but more dispersed massage area. It should, be noted that the restricted portions 3211 of the floor mat 32 are coupled together and made integrally for reducing the cost. However, the present application is not limited thereto, the restricted portions 3211 can be made individually.

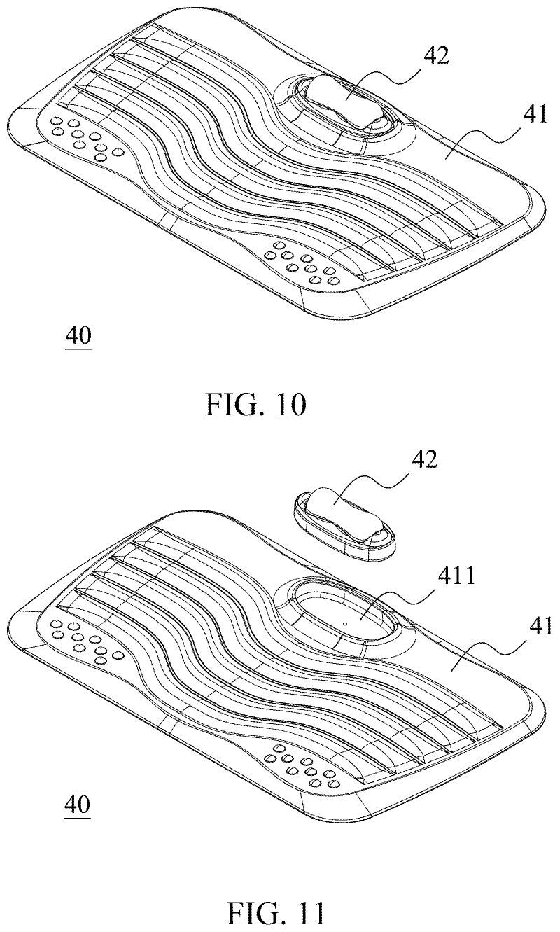

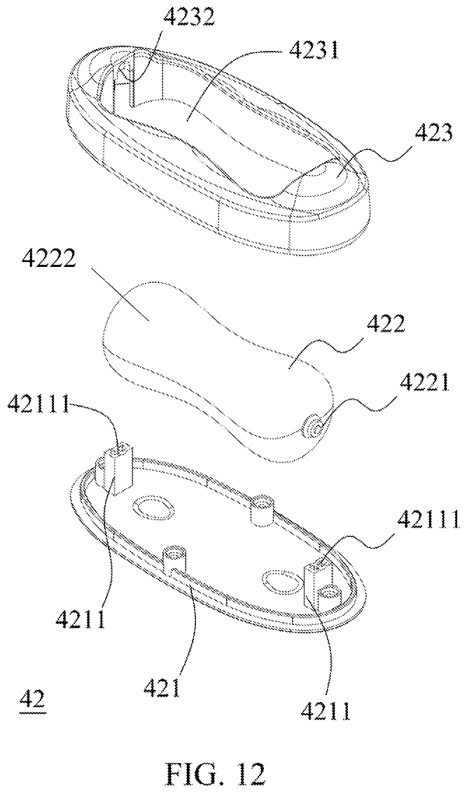

FIG. 10 is a perspective view of a floor mat 40 according to the fourth embodiment of the present application. FIG. 11 is a partially exploded perspective view of the floor mat 40 of FIG. 10. FIG. 12 is an exploded perspective view of the roller 42 of FIG. 11.

Referring to FIGS. 10-11, the floor mat 40 comprises a main body 41 and a roller 42 disposed in the accommodation space 411 of the main body 41.

In FIG. 12, the roller 42 comprises a base 421, the massagers 422 and a cover 423.

The difference between the floor mat 10 (referring to FIGS. 1-3) and floor mat 40 is the structure of the roller 42. Specifically, a base 421 of the roller 42 does not comprise the restricted portion but comprise two stands 42111 instead. Each of the stand 4211 has a lower arc-slot 42111 above it.

A massager 422 comprises protrusions 4221 (not shown in the figure on the left in the figure) and a rolling wheel 4222 coupled to the protrusions 4221. The protrusions 4221 and the rolling wheel 4222 of the massager 422 are made integrally in the present application as an example, but the present application is not limited thereto.

The protrusions 4221 are respectively arranged on the lower arc-slot 42111 of the two stands 4211 of the base 421. In addition, a cover 423 has two upper arc-slot 4232 respectively corresponding to the two lower arc-slot 42111 (not shown in the figure on the right) to cover on the base 421.

The surface of the rolling wheel 4222 is a smooth. The shape of the rolling wheel 4222 is dumbbell shaped. To meet the shape of the massager 422, the cover 423 further comprises an opening 4231 corresponding to the rolling wheel 4222.

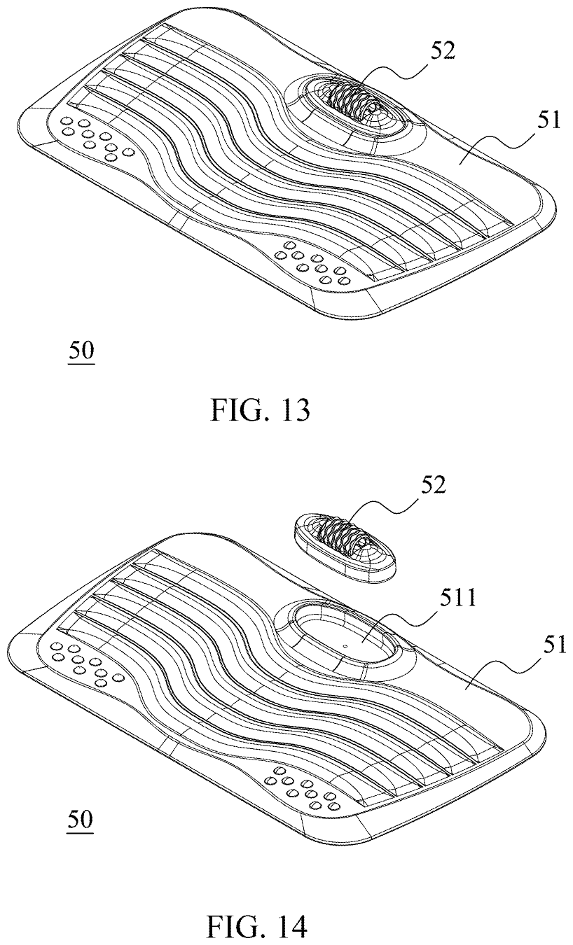

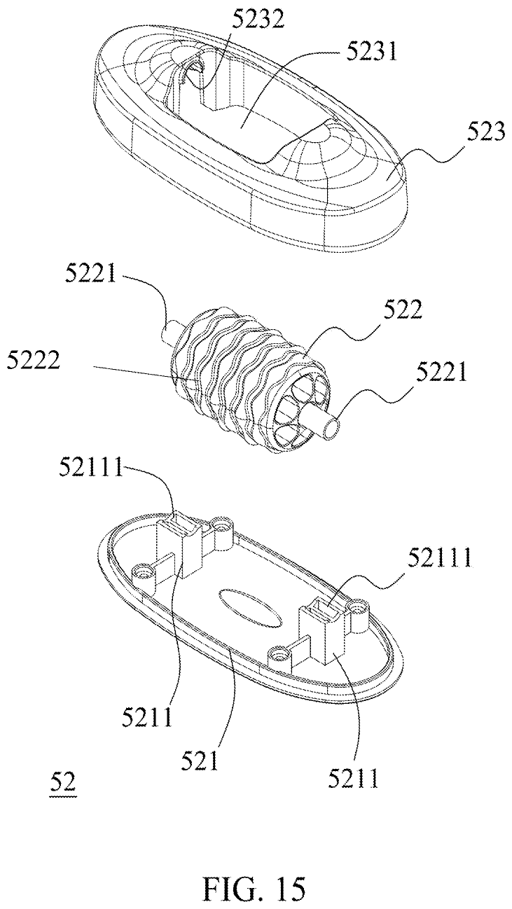

FIG. 13 is a perspective view of a floor mat 50 according to the fifth embodiment of the present application. FIG. 14 is a partially exploded perspective view of the floor mat 50 of FIG. 13. FIG. 15 is an exploded perspective view of the roller 50 of FIG. 14.

Referring to FIGS. 13-14, the floor mat 50 comprises a main body 51 and a roller 52 disposed in the accommodation space 511 of the main body 51.

In FIG. 15, the roller 52 comprises a base 521, the massagers 522 and a cover 523.

The difference between the floor mat 40 (referring to FIGS. 10-12) and floor mat 50 is the structure of the roller 52. Specifically, the roller 52 comprises a base 521, a massager 522 and a cover 523.

The massager 522 comprises protrusions 5221 and a rolling wheel 5222. Specifically, a rod is passed through a center of the rolling wheel 5222 to form the two protrusions 5221.

The rolling wheel 5222 is ellipsoid and comprises a plurality of wavy recesses. In addition, the cover 523 further comprises an opening 5231 corresponding to the rolling wheel 5222 in order to meet the shape of the massager 522.

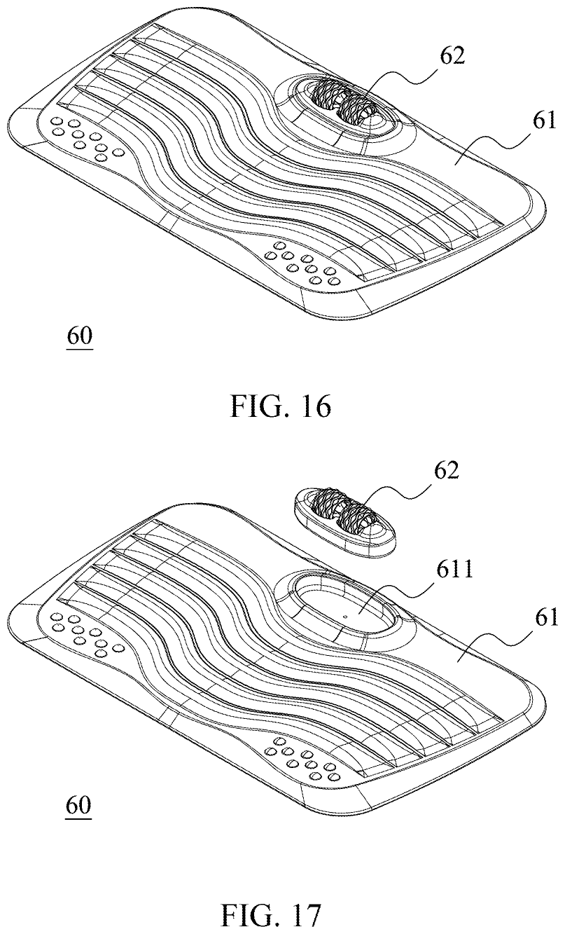

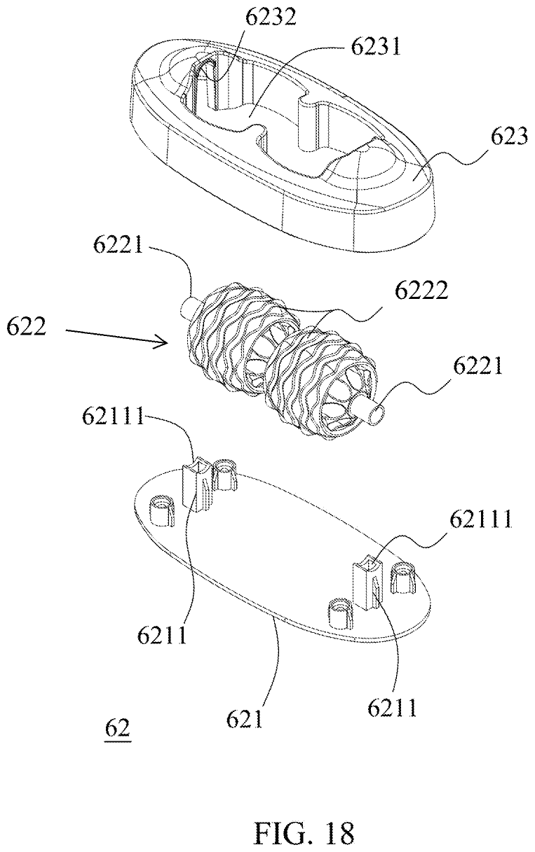

FIG. 16 is a perspective view of a floor mat 60 according to the sixth embodiment of the present application. FIG. 17 is a partially exploded perspective view of the floor mat 60 of FIG. 16. FIG. 18 is an exploded perspective view of the roller 60 of FIG. 17.

Referring to FIGS. 16-17, the floor mat 60 comprises a main body 61 and a roller 62 disposed in the accommodation space 611 of the main body 61.

In FIG. 18, the roller 62 comprises a base 621, the massagers 622 and a cover 623.

The difference between the floor mat 50 (referring to FIGS. 13-15) and floor mat 60 is the structure of the roller 62. Specifically, the massager 622 comprises two rolling wheels 6222. In addition, the cover 623 further comprises an opening 6231 corresponding to the rolling wheels 6222 in order to meet the shape of the massager 622.

Based on the above, the floor mat of the present application provides a main body suitable for the user to stand for a long time that not only relieves the pressure on the user's legs and reduces the fatigue caused by standing for a long time, but also has a great efficiency for users to further relax the body pressure by the rolling massage operation.

In addition, since the main body can be made of different materials, the user may enjoy the massage operation and have customized massage. Furthermore, since the roller is changeable, the user may even select the desired style of roller to have different types of massage.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A floor mat comprising:
a main body comprising an accommodation space; and
a changeable roller arranged in the accommodation space of the main body.

2. The floor mat as claimed in claim 1, wherein the main body is plate-shaped.

3. The floor mat as claimed in claim 1, wherein the changeable roller comprises:
a base;
a massager; and
a cover coupled to the base to form a massager space and comprising at least one opening, wherein the massager is restricted in the massager space and exposed partially from the at least one opening.

4. The floor mat as claimed in claim 3, wherein the cover comprises one opening.

5. The floor mat as claimed in claim 4, wherein the base comprises a restricted portion, the restricted portion and the opening are circular, the massager is a ball.

6. The floor mat as claimed in claim 5, wherein the ball is a metal ball.

7. The floor mat as claimed in claim 4, wherein the base comprises two stands.

8. The floor mat as claimed in claim 7, wherein the massager comprises:
protrusions coupled to the two stands; and
at least one rolling wheel coupled to the protrusions.

9. The floor mat as claimed in claim 8, wherein the at least one rolling wheel is a dumbbell shaped rolling wheel.

10. The floor mat as claimed in claim 9, wherein a surface of the dumbbell shaped rolling wheel is smooth.

11. The floor mat as claimed in claim 8, wherein the massager further comprises a rod passing through a center of the at least one rolling wheel to form the protrusions.

12. The floor mat as claimed in claim 11, wherein a surface of the at least one rolling wheel comprises a plurality of wavy recesses.

13. The floor mat as claimed in claim 12, wherein the massager comprises two rolling wheels.

14. The floor mat as claimed in claim 8, wherein the at least one rolling wheel is ellipsoid.

15. The floor mat as claimed in claim 3, wherein the cover comprises two openings.

16. The floor mat as claimed in claim 15, wherein the base comprises two restricted portions, the two restricted portions and the two openings are circular, the massager comprises two balls.

17. The floor mat as claimed in claim 16, wherein the two balls are two metal balls.

18. The floor mat as claimed in claim 3, wherein the cover comprises seven openings.

19. The floor mat as claimed in claim 18, wherein the base comprises seven restricted portions, the seven restricted portions and the seven openings are circular, the massager comprises seven balls.

20. The floor mat as claimed in claim 19, wherein the seven balls are seven metal balls.
